(19) United States
(12) Patent Application Publication
(10) Pub. No.: US 2010/0005206 A1
(43) Pub. Date: Jan. 7, 2010

(54) AUTOMATIC READ DATA FLOW CONTROL IN A CASCADE INTERCONNECT MEMORY SYSTEM

(75) Inventors: Steven J. Hnatko, Fishkill, NY (US); Kevin C. Gower, LaGrangeville, NY (US); Michael R. Trombley, Cary, NY (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/166,226

(22) Filed: Jul. 1, 2008

(51) Int. Cl. G06F 13/14

(52) U.S. Cl. 710/107

(57) ABSTRACT

Systems and methods for providing automatic read flow control in a cascade interconnect memory system. A hub device includes an interface to a channel in a cascade interconnect memory system for connecting the hub device to an upstream hub device or a memory controller. The channel includes an upstream bus and a downstream bus. The hub device also includes read data flow control logic for determining when to transmit data on the upstream bus. The determining is responsive to an order of commands received on the downstream bus and to current traffic on the upstream bus.

### BACKGROUND

This invention relates generally to computer memory systems, and more particularly to providing automatic read data flow control in a cascade interconnect memory system.

Contemporary high performance computing main memory systems are generally composed of one or more dynamic random access memory (DRAM) devices, which are connected to one or more processors via one or more memory control elements. Overall computer system performance is affected by each of the key elements of the computer structure, including the performance/structure of the processor(s), any memory cache(s), the input/output (I/O) subsystem(s), the efficiency of the memory control function(s), the main memory device(s), and the type and structure of the memory interconnect interface(s).

Extensive research and development efforts are invested by the industry, on an ongoing basis, to create improved and/or innovative solutions to maximizing overall system performance and density by improving the memory system/subsystem design and/or structure. High-availability systems present further challenges as related to overall system reliability due to customer expectations that new computer systems will markedly surpass existing systems in regard to mean-time-between-failure (MTBF), in addition to offering additional functions, increased performance, increased storage, lower operating costs, etc. Other frequent customer requirements further exacerbate the memory system design challenges, and include such items as ease of upgrade and reduced system environmental impact (such as space, power and cooling).

### SUMMARY

An exemplary embodiment includes a hub device including an interface to a channel in a cascade interconnect memory system for connecting the hub device to an upstream hub device or a memory controller. The channel includes an upstream bus and a downstream bus. The hub device also includes read data flow control logic for determining when to transmit data on the upstream bus. The determining is responsive to an order of commands received on the downstream bus and to current traffic on the upstream bus.

Another exemplary embodiment includes a memory system. The memory system includes a memory channel, a memory controller, and a hub device. The memory channel includes an upstream bus and a downstream bus. The memory controller is in communication with the memory channel and includes memory controller read data flow control logic for determining an expected return time of read data associated with a read command issued by the memory controller. The hub device includes an interface to the memory channel for connecting the hub device to the memory controller or for cascade interconnecting the hub device to an upstream hub device in the memory system. The hub device also includes hub device read data flow control logic for determining when to transmit the read data on the upstream bus. The determining is responsive to an order of commands received on the downstream bus and to current traffic on the upstream bus.

A further exemplary embodiment includes a method for automatic read data flow. The method includes receiving a downstream memory channel block at a hub device in a cascade interconnect memory system, the receiving via an upstream bus. It is determined if the downstream memory channel block includes a read command. An outstanding read data latency (ORDL) counter is decremented if the downstream memory channel block does not include a read command. If the downstream memory channel block includes a read command, then a read data buffer delay (RDBD) is calculated for the read command, a read data latency (RDL) is calculated for each frame of data returned in response to the read command, and a new ORDL is calculated based on the RDBD and the RDL. If the downstream memory channel block includes a read command and the read command is directed to a memory device associated with the hub device, then the one or more data frames returned in response to the read command are transmitted on the upstream bus after holding the data for the amount of time specified by the RDBD.

A further exemplary embodiment includes a design structure tangibly embodied in a machine readable medium for designing, manufacturing, or testing an integrated circuit. The design structure includes a hub device that includes an interface to a channel in a cascade interconnect memory system for connecting the hub device to an upstream hub device or a memory controller. The channel includes an upstream bus and a downstream bus. The hub device also includes read data flow control logic for determining when to transmit data on the upstream bus, the determining responsive to an order of commands received on the downstream bus and to current traffic on the upstream bus.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE SEVERAL VIEWS OF THE DRAWINGS

Referring now to the drawings wherein like elements are numbered alike in the several FIGURES:

FIG. 1 depicts a cascade interconnect memory system with automatic read data flow control that may be implemented by an exemplary embodiment;

FIG. 2 depicts a cascade interconnect memory system with automatic read data flow control that may be implemented by an exemplary embodiment;

FIG. 3 is a timing diagram of return read data frames that may be implemented by an exemplary embodiment;

FIG. 4 is a timing diagram of return read data frames with two hub devices that may be implemented by an exemplary embodiment;

FIG. 5 is a timing diagram that illustrates the insertion of idle blocks into an upstream data channel that may be implemented by an exemplary embodiment;

FIG. 6 depicts an exemplary process for automatic read data flow control in a cascade interconnect memory system that may be implemented by an exemplary embodiment; and

FIG. 7 is a flow diagram of a design process used in semiconductor design, manufacture and/or test.

### DETAILED DESCRIPTION

A cascaded interconnect memory system shares a common memory channel between a number of hubs (or buffer devices) chained to a host memory controller. Since the data bus to the controller is a shared resource among all hubs in the chain, care must be taken by the controller to manage the read data traffic back to the controller in order to avoid date collisions between the hubs. To do so, it must schedule read data requests to the hubs in order to ensure collision free read data traffic on the bus, potentially reducing the bandwidth utilization of the data channel. An alternative implementation is for a mechanism to buffer read data from each hub until an available time slot can be found in which to insert the read data. This requires the additional complexity of the host controller calculating required buffer delay for the hub's data before sending the read request to the hub, as well as transmitting the buffer delay information to the hub as part of the read request.

A cascaded interconnect memory system includes a series of hub devices in a chained configuration connected to a host memory controller. In an exemplary embodiment, the hub devices are located on DIMMS that also include one or more memory devices. Each hub communicates with the memory devices located on the DIMM as well as upstream and downstream hubs in the chain. In an exemplary embodiment of the present invention, the memory controller learns the optimal read data latency from each hub during an initialization stage. The latency for each hub is stored in the controller and each hub in the chain. Read data requests are cascaded down the chain and targeted to a specific hub. Each hub monitors each request transmitted downstream and forwards it downstream to the next hub. This allows each hub to monitor the read data occupancy of the memory channel.

In an exemplary embodiment, read data buffers and read data delays are used to prevent collisions between local read data and read data from cascaded hubs. The return time of the most recent read operation is tracked by the host controller and all hubs in the chain. When a new read request is issued, a deterministic amount of delay is added to the read data return time based on the configured latencies of the hubs and the last outstanding return time. If the last outstanding return time indicates the channel will be available when the memory read data is returned, the data will immediately be inserted into the upstream data channel. If the channel is not available at the time the data is returned from the memory device, the hub will buffer the data on board the hub device for a predetermined amount of read data buffer delay time. When the read data buffer delay time expires, the hub transmits the read data to the host. While the hub is driving read data upstream, data received from the downstream hubs is lost. At all other times, the downstream data is cascaded upstream to the controller. This delay calculation and buffer technique ensures that each read data request is granted a collision free time slot on the upstream channel. An advantage of this system is that the read data buffer delay does not need to be transmitted to the hub as part of the read request command. It is determined on the fly based on the read request traffic down the channel and the learned read data latency of each hub. The controller will also calculate each read request's data buffer delay so as to know exactly when the returned read data is to be expected. This also removes the need for any “data valid” indication to be sent upstream to the memory controller as part of the returned read data, allowing for tight return read data packing to fully leverage available memory channel bandwidth.

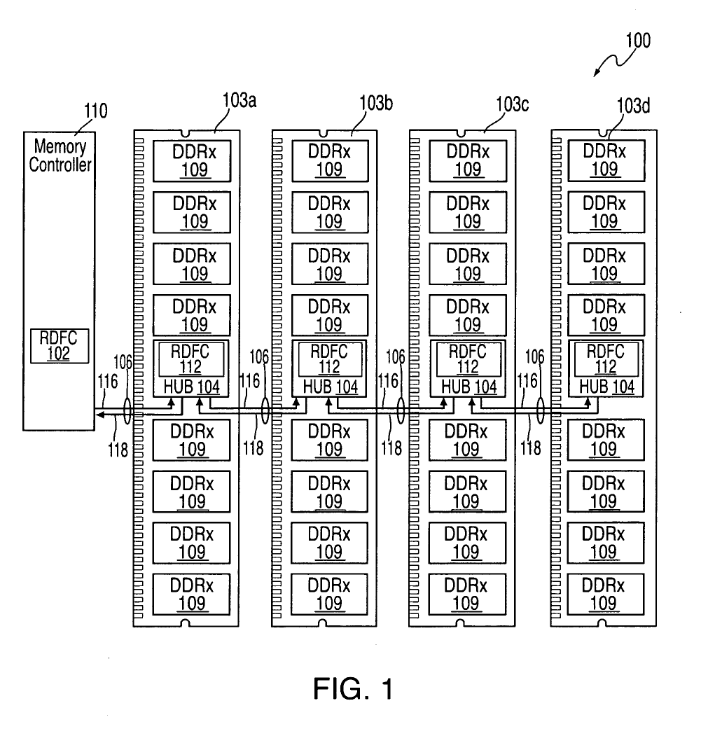

Turning now to FIG. 1, an example of a memory system 100 that includes fully buffered dual in-line memory modules (DIMMs) communicating via a high-speed channel and using read data flow control (RDFC) is depicted. The memory system 100 may be incorporated in a host processing system as main memory for the processing system. The memory system 100 includes a number of DIMMs 103a, 103b, 103c and 103d with memory hub devices 104 communicating via a channel 106 or a cascade-interconnected bus (made up of a differential unidirectional upstream bus 118 and a differential unidirectional downstream bus 116). The DIMMs 103a-103d can include multiple memory devices 109, which may be double data rate (DDR) dynamic random access memory (DRAM) devices, as well as other components known in the art, e.g., resistors, capacitors, etc. The memory devices 109 are also referred to as DRAM 109 or DDRx 109, as any version of DDR may be included on the DIMMs 103a-103d, e.g., DDR2, DDR3, DDR4, etc. A memory controller 110 interfaces with DIMM 103a, sending commands, address and data values via the channel 106 that may target any of the DIMMs 103a-103d. The commands, address and data values may be formatted as frames and serialized for transmission at a high data rate.

In an exemplary embodiment, when a DIMM receives a frame from an upstream DIMM or the memory controller 110, it redrives the frame to the next DIMM in the daisy chain (e.g., DIMM 103a redrives to DIMM 103b, DIMM 103b redrives to DIMM 103c, etc.). At the same time, the DIMM decodes the frame to determine the contents. Thus, the redrive and command decode at a DIMM can occur in parallel, or nearly in parallel. If the command is a read request, all DIMMS 103a-103d and the memory controller 110 utilize contents of the command to keep track of read data traffic on the upstream bus 118.

The hub devices 104 on the DIMMs receive commands via an interface (e.g. a port) to the channel 106. The interface on the hub device 104 includes, among other components, a receiver and a transmitter. In an exemplary embodiment, a hub device 104 includes both an upstream interface for communicating with an upstream hub device 104 or memory controller 110 via the channel 106 and a downstream interface for communicating with a downstream hub device 104 via the channel 106.

As depicted in the embodiment shown in FIG. 1, the memory controller 110 includes memory controller RDFC logic 102 to keep track of read data traffic on the upstream bus 118. In addition, each DIMM 103a-103d includes hub device RDFC logic 112 located on its hub device 104 for keeping track of read data traffic on the upstream bus 118.

Although only a single memory channel 106 is shown in FIG. 1 connecting the memory controller 110 to a single memory device hub 104, systems produced with these modules may include more than one discrete memory channel from the memory controller, with each of the memory channels operated singly (when a single channel is populated with modules) or in parallel (when two or more channels are populated with modules) to achieve the desired system functionality and/or performance. Moreover, any number of lanes can be included in the channel 106. For example, the downstream bus 116 can include 13 bit lanes, 2 spare lanes and a clock lane, while the upstream bus 118 may include 20 bit lanes, 2 spare lanes and a clock lane.

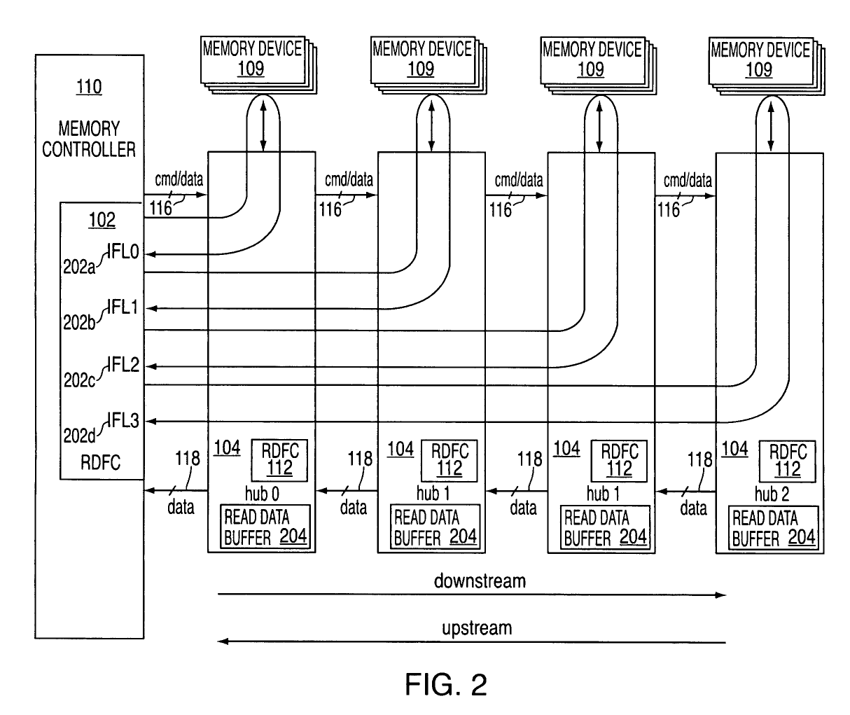

FIG. 2 depicts a memory system configuration that may be implemented by an exemplary embodiment. The hub devices 104 are chained together and to the host memory controller 110. The hub devices 104 communicate to downstream hub devices 104 via a downstream bus 116 that carries commands and data, to an upstream hub device 104 or memory controller 110 via an upstream bus 118 bus that carries data, and to memory devices 109.

In an exemplary embodiment, the read data latency of each hub device 104 is calculated and written into the appropriate configuration registers in both the memory controller 110 and the hub devices 104. In an exemplary embodiment, a hub device 104 contains a fixed data pattern register in the RDFC logic 112 which the memory controller 110 repeatedly reads while varying its expected read data latency time. In an alternate exemplary embodiment, the fixed data pattern registers are located elsewhere in the hub device 104 (i.e., not in the RDFC logic 112). When the valid read data latency is detected, the memory controller 110 stores this as the initial frame latency (IFL) in the RDFC logic 102 for that hub device 104 in the channel. The IFL for that hub device 104 is also sent as configuration data to each hub device 104 in the channel and stored by each hub device 104 in circuits associated with the RDFC logic 112. The memory controller 110 repeats the process for each hub device 104 in the channel.

Upon initialization completion, the controller 110 and each hub device 104 will have the IFLs 202a-202d for every hub device 104 in the channel saved as configuration data in the RDFC logic 102 112 or accessible by the RDFC logic 102,112. In an exemplary embodiment, the IFLs 202a-202d are updated on a periodic basis during system run-time. In another exemplary embodiment, the memory controller 110 and hub device 104 upstream data receivers align all incoming read data to a four unit interval boundary using built-in fifo logic. Therefore, read data latency and read data buffer delay are expressed in units of memory channel blocks (e.g., four memory channel transfers). The IFL is also measured in terms of these memory channel blocks. The IFL is measured from the time that the read request is issued by the memory controller 110 to the time that the first block of returned read data is received by the host memory controller 110. The IFLs 202a-202d for each hub device 104 in the channel are unique and account for variability in latencies such as the memory read data access time, the physical proximity of the hub devices 104 to the memory controller 110 and to each other, as well as data capture and alignment between each hub device 104 and the memory controller 110.

The memory controller 110 (or host) and hub devices 104 continuously calculate the remaining latency from the most recently issued read command on the memory channel 106 using outstanding read data latency (ORDL) counters located in or accessible by the RDFC logic 102 112. Each downstream memory channel block that does not include a read command will cause the ORDL counters to be decremented by one. When a new read request is issued, a new ORDL value will be loaded based on the return time of the last read data frame (two block unit) from the access. An exemplary embodiment of how this is calculated is described below.

For each read request issued down the channel (i.e., via the downstream bus 116), the memory controller 110 and each hub device 104 will calculate the read data buffer delay (RDBD) to determine the number of blocks that the read data will be buffered in the read data buffer 204 located on the hub device 104. If the initial frame latency (IFL) for the addressed hub is larger than the current ORDL, then no RDBD is required as the channel will be available by the time the read data is ready. If the IFL is equal to or smaller than the current ORDL, then a non-zero RDBD will be generated. In an exemplary embodiment, the RDBD is calculated in blocks as follows:

RDBD=MAX(0, ORDL−IFL+2).

Return read data is transmitted upstream to the controller as a series of read data frames (two block unit). The latency of the initial frame is referred to as initial frame latency (IFL). The latency of the initial frame and subsequent frames is further described by the subsequent frame latency (SFL). The SFL describes additional latency added to the IFL for all return read data frames.

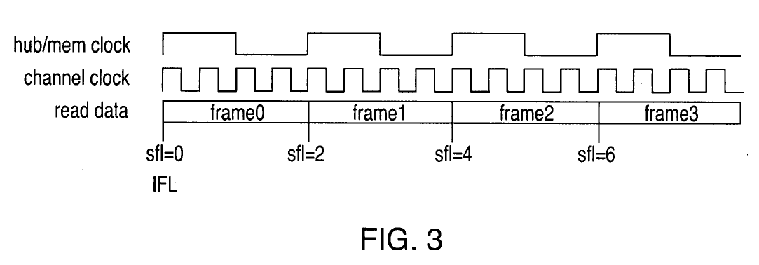

FIG. 3 illustrates exemplary return read data frames with the SFL adders shown for a memory system where the channel clock is four times the speed of the hub device clock. Returned memory read data may occupy two frames (four blocks) or four frames (eight blocks) depending on the memory access size. The SFL values are 0,2,4,6 for read data frames 0,1,2,3 respectively.

The IFL and SFL allow for the description of the latency of each read data frame for an unloaded (not busy) memory channel. When non-zero RDBD is calculated, it is factored into the return read latency (RDL) for each data frame. The RDL of each returned upstream frame, numbered x, in a read access may be expressed as:

RDL(x)=IFL+MAX(2x+RDBD, SFL(x)); where x=0,1 for a two frame read data return and x=0,1,2,3 for a four frame read data return.

When a read request is issued to a hub in the channel, each hub calculates the ORDL of the channel and loads the new value into its ORDL counters. This new ORDL will take into account any RDBD which is calculated for the read request. The new ORDL may be described by:

ORDL_new=RDL(max); where max=1 for a two frame read data return and max=3 for a four frame read data return.

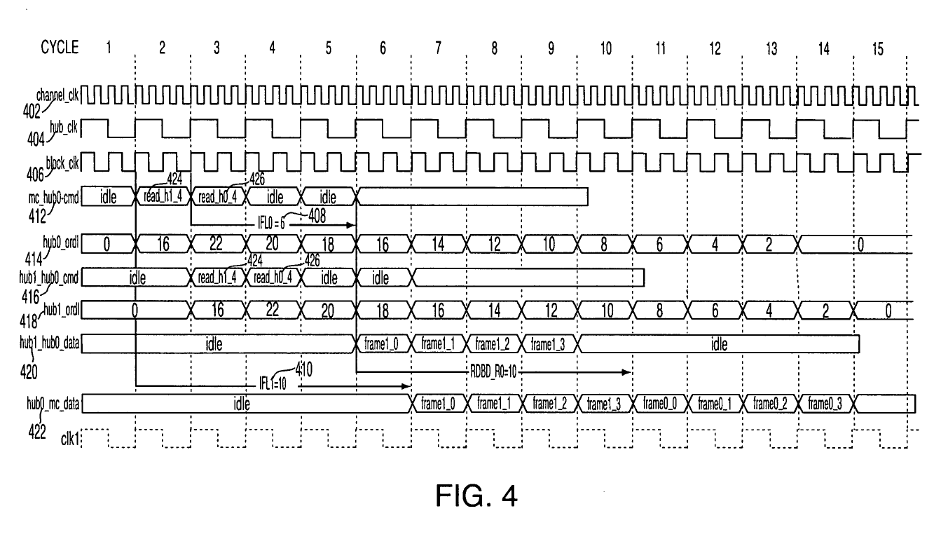

FIG. 4 depicts an example case of two hub devices chained to a host memory controller in a cascade interconnect memory system. In this example, the memory and hub device clocks 404 are running at one quarter of the frequency of the channel clocks 402. This creates data frames of one hub device clock cycle width, and data blocks of one-half hub device clock cycle width. The channel clock rate to memory clock rate can be expressed as a ratio of 4:1 (four channels clocks per one memory/hub device clock). The block clock 406 is also shown to be two times the frequency of the memory/hub device clock 402. The block clock 406 is tied to the channel clock 402 with a 2:1 ratio.

In the example, the IFLs for hub0 and hub1 have been determined during the initialization sequence. Hub0, being closest in proximity to the host memory controller, has the smaller IFL(IFL0 408) equal to six blocks. Hub1's IFL (IFL1 410) is equal to ten blocks.

The example shows a two read command sequence. The first read is issued from the controller to hub0 on the mc_hub0_cmd bus 412 on cycle two. The read request is targeted at hub1 and will return four frames of read data. Hub0 forwards the command downstream on the hub0_hub1_cmd bus 416 where it is received by hub1 at cycle three. Also during cycle two, hub0 calculates the RDBD for the read request based on the equation: RDBD=MAX (0, ORDL−IFL+2). Since hub0's current ORDL count 414 is equal to zero, the RDBD for the read request is zero (0=MAX(0, 0-10 (IFL1)+2). Hub0 also calculates the new ORDL using the equation: new_ORDL=IFL+MAX(2(3)+RDBD, SFL(3)). Since the RDBD was computed to be zero, the new-ORDL=10+MAX(6, 6)=16. At this point, hub0 is finished processing the read_h1_{—}4 command 412 and has an ORDL count 414 of 16 blocks.

Hub1 receives the read_h1_{—}4 command 412 on cycle three and takes the same action as hub0. Hub1 calculates an RDBD of 0 and an ORDL count 418 of 16 for the read_h1_{—}4 command 424. Since the command was targeted to hub1, it also process the read request and when the memory data becomes available, transmits it back to the controller on the hub1_hub0_data bus 420 with no additional buffer delay (RDBD=0).

On cycle three, hub0 receives a second read request from the host controller, read_h0_{—}4 command 426. The command is targeted at hub0 and will return four frames of read data. Again, hub0 forwards the command to hub1 on the hub0_hub1_cmd bus 416, calculates the RDBD and ORDL count 414 and begins processing the read request to memory. The RDBD is calculated as RDBD=MAX(0, 14-6(IFL0)+2)=10 blocks. This indicates that when the hub0 read data is returned from memory, it must be held in hub0's read data buffers for ten blocks of time before sending upstream on the hub0_mc_data bus 422. The new ORDL is also calculated using the RDBD count of ten: new ORDL=6(IFL0)+MAX(2(3)+10(RDBD), 6). This gives hub0 a new ORDL count 414 of 22. Hub1 receives the read_h0_{—}4 command on cycle four and computes the same RDBD=10 and new ORDL count 418 equal to 22. Since no more read commands are issued by the host memory controller, the ORDL counts for both hub0 and hub1 will are decremented by two each hub clock cycle following the read requests (two blocks per hub clock cycle).

On cycle 6, hub1 receives its memory read data and forwards it immediately (RDBD=0) to hub0 on the hub1_hub0_data bus 420. The first read data frame (frame1_{—}0) is received by the memory controller on the hub0_mc_data bus 422 at cycle seven. This shows the IFL1=10 blocks from issue of read command on the mc_hub0_cmd bus 412 to receipt of first data frame on hub0_mc_data bus 422 ten blocks (or five hub clock cycles) later.

On cycle six, hub0's read data has been received, however the hub0_mc_data bus 422 is in use with hub1's read data. Hub0's read data must wait in hub0's read data buffers for the previously computed ten blocks (RDBD=10). Once the ten blocks have expired, hub0 immediately transmits its read data frames, starting with frame1_{—}0 to the controller on the hub0_mc_data bus 422, resulting in a continuous stream of read data to the controller first from hub1 then hub0 with no gaps between. This example illustrates one way that a read data buffer delay is calculated on the fly for each read request. With proper ordering and spacing of read requests to the various hubs on the channel, high read data bus utilization of available channel bandwidth is achieved.

The description and example illustrate a memory system with a channel clock operating at a 4:1 ratio with respect to the hub/memory clocks, however multiple channel clock/memory clock gear ratios are supported. For systems where the hub/memory clock ratio exceeds 4:1 (e.g., 5:1, 6:1, 8:1) modifications are made to the SFL factors when calculating the new_ORDL. Since the hub channel data width is fixed, when running in clocking modes greater than 4:1, idle blocks or frames are inserted into the upstream data channel when returning read data is due. The idle blocks or frames are inserted to correct for bandwidth mismatches between the memory data from the hub and the upstream channel data rate.

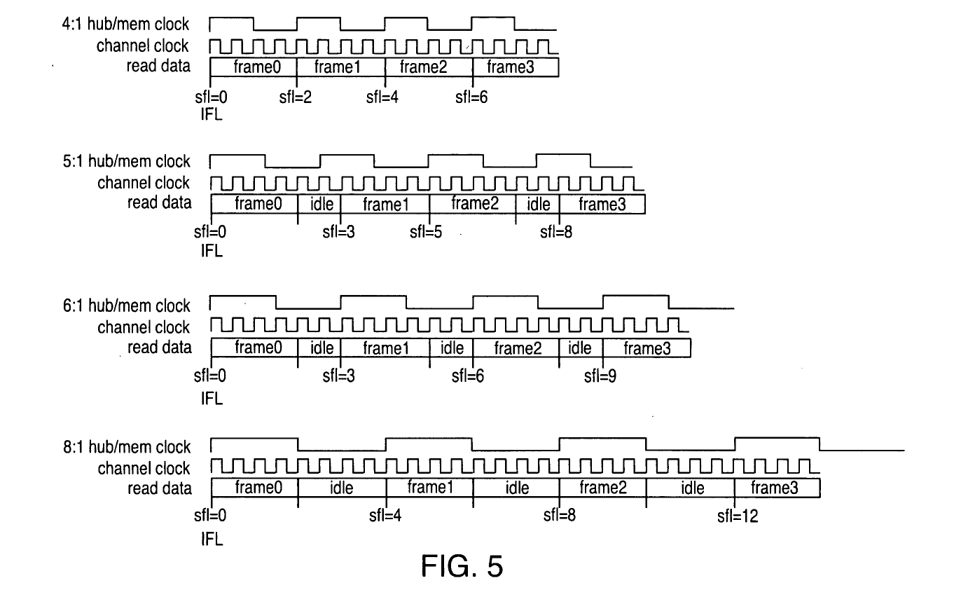

FIG. 5 illustrates the insertion of idle blocks into the upstream data channel when unloading read data onto an empty (RDBD=0) channel. The idle blocks and frames allow the hub to collect up necessary read data frames in order to send them up the channel with minimal latency and minimal idle gaps in the data stream. The idle blocks shown in FIG. 5 apply to unloading read data onto an empty data channel. If the data channel is busy with hub read data, (RDBD is not equal to zero) the idle blocks can be eliminated. Every block of RDBD delay added to a read request may eliminate one idle block in the upstream return read data stream. For example, if the channel clock is running with a 6:1 ratio with respect to the memory clock, an RDBD of one would eliminate the idle block transmitted between data frames zero and one. An RDBD count of three would eliminate all idle blocks for a four data frame data return. With an 8:1 clock ration, an RDBD of two would eliminate data idles for a two data frame return, and an RDBD of six would eliminate all idles for a four frame data return.

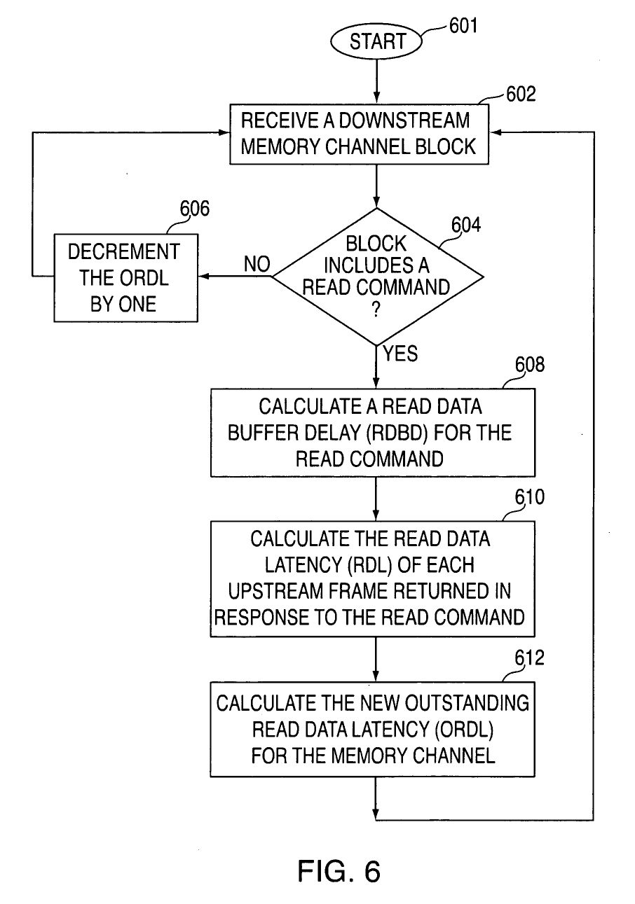

In an exemplary embodiment, the process described above is performed by the RDFC logic located in each of the hub devices and the memory controller. An embodiment of a process performed at each hub device is depicted in FIG. 6. The process is started at block 601 when the cascade interconnect memory system is executing in a run time mode to process memory access requests. At block 602, a downstream memory channel block is received at the hub device. At block 604 it is determined if the block includes a read command. If the block does not include a read command, then block 606 is performed and the ORDL is decremented by one. Processing then continues at block 602 when a downstream memory channel block is received.

If the downstream memory channel block includes a read command, as determined at block 604, then block 608 is performed. At block 608, a RDBD is calculated for the read command. Next, block 610 is performed and the RDL is calculated for each upstream frame returned in response to the read command. This causes each upstream frame returned in response to the read command to be held in a read data queue in the hub device based on the value of its associated RDL. The first upstream frame may have an RDL of zero, in which case the read frames will not be held in a queue. In this case, the queue will be bypassed and the frame will be sent upstream with zero additional delay. At block 612, a new ORDL is calculated for the memory channel. Processing then continues at block 602 when a downstream memory channel block is received.

Similar processing is utilized by the memory controller RDFC logic. The memory controller RDFC logic may also include instructions to generate the read data latencies (e.g. the IFLs) for each hub device 104.

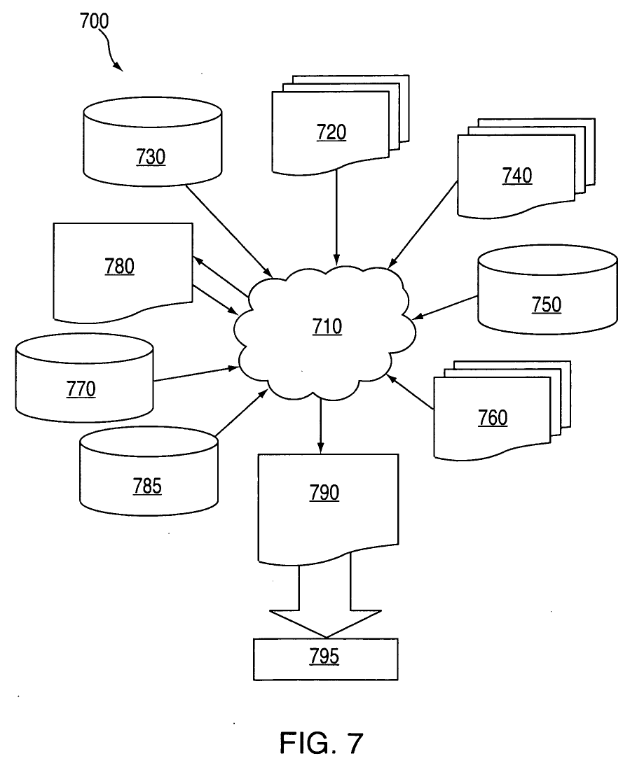

FIG. 7 shows a block diagram of an exemplary design flow 700 used for example, in semiconductor IC logic design, simulation, test, layout, and manufacture. Design flow 700 includes processes and mechanisms for processing design structures or devices to generate logically or otherwise functionally equivalent representations of the design structures and/or devices described above and shown in FIG. 1 and/or FIG. 2. The design structures processed and/or generated by design flow 700 may be encoded on machine readable transmission or storage media to include data and/or instructions that when executed or otherwise processed on a data processing system generate a logically, structurally, mechanically, or otherwise functionally equivalent representation of hardware components, circuits, devices, or systems. Design flow 700 may vary depending on the type of representation being designed. For example, a design flow 700 for building an application specific IC (ASIC) may differ from a design flow 700 for designing a standard component or from a design flow 700 for instantiating the design into a programmable array, for example a programmable gate array (PGA) or a field programmable gate array (FPGA) offered by Altera® Inc. or Xilinx® Inc.

FIG. 7 illustrates multiple such design structures including an input design structure 720 that is preferably processed by a design process 710. Design structure 720 may be a logical simulation design structure generated and processed by design process 710 to produce a logically equivalent functional representation of a hardware device. Design structure 720 may also or alternatively comprise data and/or program instructions that when processed by design process 710, generate a functional representation of the physical structure of a hardware device. Whether representing functional and/or structural design features, design structure 720 may be generated using electronic computer-aided design (ECAD) such as implemented by a core developer/designer. When encoded on a machine-readable data transmission, gate array, or storage medium, design structure 720 may be accessed and processed by one or more hardware and/or software modules within design process 710 to simulate or otherwise functionally represent an electronic component, circuit, electronic or logic module, apparatus, device, or system such as those shown in FIG. 1 and/or FIG. 2. As such, design structure 720 may comprise files or other data structures including human and/or machine-readable source code, compiled structures, and computer-executable code structures that when processed by a design or simulation data processing system, functionally simulate or otherwise represent circuits or other levels of hardware logic design. Such data structures may include hardware-description language (HDL) design entities or other data structures conforming to and/or compatible with lower-level HDL design languages such as Verilog and VHDL, and/or higher level design languages such as C or C++.

Design process 710 preferably employs and incorporates hardware and/or software modules for synthesizing, translating, or otherwise processing a design/simulation functional equivalent of the components, circuits, devices, or logic structures shown in FIG. 1 and/or FIG. 2 to generate a netlist 780 which may contain design structures such as design structure 720. Netlist 780 may comprise, for example, compiled or otherwise processed data structures representing a list of wires, discrete components, logic gates, control circuits, I/O devices, models, etc. that describes the connections to other elements and circuits in an integrated circuit design. Netlist 780 may be synthesized using an iterative process in which netlist 780 is resynthesized one or more times depending on design specifications and parameters for the device. As with other design structure types described herein, netlist 780 may be recorded on a machine-readable data storage medium or programmed into a programmable gate array. The medium may be a non-volatile storage medium such as a magnetic or optical disk drive, a programmable gate array, a compact flash, or other flash memory. Additionally, or in the alternative, the medium may be a system or cache memory, buffer space, or electrically or optically conductive devices and materials on which data packets may be transmitted and intermediately stored via the Internet, or other networking suitable means.

Design process 710 may include hardware and software modules for processing a variety of input data structure types including netlist 780. Such data structure types may reside, for example, within library elements 730 and include a set of commonly used elements, circuits, and devices, including models, layouts, and symbolic representations, for a given manufacturing technology (e.g., different technology nodes, 32 nm, 45 nm, 90 nm, etc.). The data structure types may further include design specifications 740, characterization data 750, verification data 760, design rules 770, and test data files 785 which may include input test patterns, output test results, and other testing information. Design process 710 may further include, for example, standard mechanical design processes such as stress analysis, thermal analysis, mechanical event simulation, process simulation for operations such as casting, molding, and die press forming, etc. One of ordinary skill in the art of mechanical design can appreciate the extent of possible mechanical design tools and applications used in design process 710 without deviating from the scope and spirit of the invention. Design process 710 may also include modules for performing standard circuit design processes such as timing analysis, verification, design rule checking, place and route operations, etc.

Design process 710 employs and incorporates logic and physical design tools such as HDL compilers and simulation model build tools to process design structure 720 together with some or all of the depicted supporting data structures along with any additional mechanical design or data (if applicable), to generate a second design structure 790. Design structure 790 resides on a storage medium or programmable gate array in a data format used for the exchange of data of mechanical devices and structures (e.g. information stored in a IGES, DXF, Parasolid XT, JT, DRG, or any other suitable format for storing or rendering such mechanical design structures). Similar to design structure 720, design structure 790 preferably comprises one or more files, data structures, or other computer-encoded data or instructions that reside on transmission or data storage media and that when processed by an ECAD system generate a logically or otherwise functionally equivalent form of one or more of the embodiments of the invention shown in FIG. 1 and/or FIG. 2. In one embodiment, design structure 790 may comprise a compiled, executable HDL simulation model that functionally simulates the devices shown in FIG. 1 and/or FIG. 2.

Design structure 790 may also employ a data format used for the exchange of layout data of integrated circuits and/or symbolic data format (e.g. information stored in a GDSII (GDS2), GL1, OASIS, map files, or any other suitable format for storing such design data structures). Design structure 790 may comprise information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure as described above and shown in FIG. 1 and/or FIG. 2. Design structure 790 may then proceed to a stage 795 where, for example, design structure 790: proceeds to tape-out, is released to manufacturing, is released to a mask house, is sent to another design house, is sent back to the customer, etc.

In an exemplary embodiment, hub devices may be connected to the memory controller through a multi-drop or point-to-point bus structure (which may further include a cascade connection to one or more additional hub devices). Memory access requests are transmitted by the memory controller through the bus structure (e.g., the memory bus) to the selected hub(s). In response to receiving the memory access requests, the hub device translates the memory access requests to control the memory devices to store write data from the hub device or to provide read data to the hub device. Read data is encoded into one or more communication packet(s) and transmitted through the memory bus(es) to the memory controller.

In alternate exemplary embodiments, the memory controller(s) may be integrated together with one or more processor chips and supporting logic, packaged in a discrete chip (commonly called a “northbridge” chip), included in a multi-chip carrier with the one or more processors and/or supporting logic, or packaged in various alternative forms that best match the application/environment. Any of these solutions may or may not employ one or more narrow/high speed links to connect to one or more hub chips and/or memory devices.

The memory modules may be implemented by a variety of technology including a DIMM, a single in-line memory module (SIMM) and/or other memory module or card structures. In general, a DIMM refers to a small circuit board which is comprised primarily of random access memory (RAM) integrated circuits or die on one or both sides with signal and/or power pins on both sides of the board. This can be contrasted to a SIMM which is a small circuit board or substrate composed primarily of RAM integrated circuits or die on one or both sides and single row of pins along one long edge. DIMMs have been constructed with pincounts ranging from 100 pins to over 300 pins. In exemplary embodiments described herein, memory modules may include two or more hub devices.

In exemplary embodiments, the memory bus is constructed using multi-drop connections to hub devices on the memory modules and/or using point-to-point connections. The downstream portion of the controller interface (or memory bus), referred to as the downstream bus, may include command, address, data and other operational, initialization or status information being sent to the hub devices on the memory modules. Each hub device may simply forward the information to the subsequent hub device(s) via bypass circuitry; receive, interpret and re-drive the information if it is determined to be targeting a downstream hub device; re-drive some or all of the information without first interpreting the information to determine the intended recipient; or perform a subset or combination of these options.

The upstream portion of the memory bus, referred to as the upstream bus, returns requested read data and/or error, status or other operational information, and this information may be forwarded to the subsequent hub devices via bypass circuitry; be received, interpreted and re-driven if it is determined to be targeting an upstream hub device and/or memory controller in the processor complex; be re-driven in part or in total without first interpreting the information to determine the intended recipient; or perform a subset or combination of these options.

In alternate exemplary embodiments, the point-to-point bus includes a switch or bypass mechanism which results in the bus information being directed to one of two or more possible hub devices during downstream communication (communication passing from the memory controller to a hub device on a memory module), as well as directing upstream information (communication from a hub device on a memory module to the memory controller), often by way of one or more upstream hub devices. Further embodiments include the use of continuity modules, such as those recognized in the art, which, for example, can be placed between the memory controller and a first populated hub device (i.e., a hub device that is in communication with one or more memory devices), in a cascade interconnect memory system, such that any intermediate hub device positions between the memory controller and the first populated hub device include a means by which information passing between the memory controller and the first populated hub device can be received even if the one or more intermediate hub device position(s) do not include a hub device. The continuity module(s) may be installed in any module position(s), subject to any bus restrictions, including the first position (closest to the main memory controller, the last position (prior to any included termination) or any intermediate position(s). The use of continuity modules may be especially beneficial in a multi-module cascade interconnect bus structure, where an intermediate hub device on a memory module is removed and replaced by a continuity module, such that the system continues to operate after the removal of the intermediate hub device. In more common embodiments, the continuity module(s) would include either interconnect wires to transfer all required signals from the input(s) to the corresponding output(s), or be re-driven through a repeater device. The continuity module(s) might further include a non-volatile storage device (such as an EEPROM), but would not include main memory storage devices.

In exemplary embodiments, the memory system includes one or more hub devices on one or more memory modules connected to the memory controller via a cascade interconnect memory bus, however other memory structures may be implemented such as a point-to-point bus, a multi-drop memory bus or a shared bus. Depending on the signaling methods used, the target operating frequencies, space, power, cost, and other constraints, various alternate bus structures may be considered. A point-to-point bus may provide the optimal performance in systems produced with electrical interconnections, due to the reduced signal degradation that may occur as compared to bus structures having branched signal lines, switch devices, or stubs. However, when used in systems requiring communication with multiple devices or subsystems, this method will often result in significant added component cost and increased system power, and may reduce the potential memory density due to the need for intermediate buffering and/or re-drive.

Although not shown in the Figures, the memory modules or hub devices may also include a separate bus, such as a ‘presence detect’ bus, an I2C bus and/or an SMBus which is used for one or more purposes including the determination of the hub device an/or memory module attributes (generally after power-up), the reporting of fault or status information to the system, the configuration of the hub device(s) and/or memory subsystem(s) after power-up or during normal operation or other purposes. Depending on the bus characteristics, this bus might also provide a means by which the valid completion of operations could be reported by the hub devices and/or memory module(s) to the memory controller(s), or the identification of failures occurring during the execution of the main memory controller requests.

Performances similar to those obtained from point-to-point bus structures can be obtained by adding switch devices. These and other solutions offer increased memory packaging density at lower power, while retaining many of the characteristics of a point-to-point bus. Multi-drop busses provide an alternate solution, albeit often limited to a lower operating frequency, but at a cost/performance point that may be advantageous for many applications. Optical bus solutions permit significantly increased frequency and bandwidth potential, either in point-to-point or multi-drop applications, but may incur cost and space impacts.

As used herein the term “buffer” or “buffer device” refers to a temporary storage unit (as in a computer), especially one that accepts information at one rate and delivers it another. In exemplary embodiments, a buffer is an electronic device that provides compatibility between two signals (e.g., changing voltage levels or current capability). The term “hub” is sometimes used interchangeably with the term “buffer.” A hub is a device containing multiple ports that is connected to several other devices. A port is a portion of an interface that serves a congruent I/O functionality (e.g., a port may be utilized for sending and receiving data, address, and control information over one of the point-to-point links, or busses). A hub may be a central device that connects several systems, subsystems, or networks together. A passive hub may simply forward messages, while an active hub, or repeater, amplifies and refreshes the stream of data which otherwise would deteriorate over a distance. The term hub device, as used herein, refers to a hub chip that includes logic (hardware and/or software) for performing memory functions.

Also as used herein, the term “bus” refers to one of the sets of conductors (e.g., wires, and printed circuit board traces or connections in an integrated circuit) connecting two or more functional units in a computer. The data bus, address bus and control signals, despite their names, constitute a single bus since each are often useless without the others. A bus may include a plurality of signal lines, each signal line having two or more connection points, that form a main transmission path that electrically connects two or more transceivers, transmitters and/or receivers. The term “bus” is contrasted with the term “channel” which is often used to describe the function of a “port” as related to a memory controller in a memory system, and which may include one or more busses or sets of busses. The term “channel” as used herein refers to a port on a memory controller. Note that this term is often used in conjunction with I/O or other peripheral equipment, however the term channel has been adopted by some to describe the interface between a processor or memory controller and one of one or more memory subsystem(s).

Further, as used herein, the term “daisy chain” refers to a bus wiring structure in which, for example, device A is wired to device B, device B is wired to device C, etc. The last device is typically wired to a resistor or terminator. All devices may receive identical signals or, in contrast to a simple bus, each device may modify one or more signals before passing them on. A “cascade” or cascade interconnect’ as used herein refers to a succession of stages or units or a collection of interconnected networking devices, typically hubs, in which the hubs operate as a logical repeater, further permitting merging data to be concentrated into the existing data stream. Also as used herein, the term “point-to-point” bus and/or link refer to one or a plurality of signal lines that may each include one or more terminators. In a point-to-point bus and/or link, each signal line has two transceiver connection points, with each transceiver connection point coupled to transmitter circuitry, receiver circuitry or transceiver circuitry. A signal line refers to one or more electrical conductors or optical carriers, generally configured as a single carrier or as two or more carriers, in a twisted, parallel, or concentric arrangement, used to transport at least one logical signal.

Memory devices are generally defined as integrated circuits that are composed primarily of memory (storage) cells, such as DRAMs (Dynamic Random Access Memories), SRAMs (Static Random Access Memories), FeRAMs (Ferro-Electric RAMs), MRAMs (Magnetic Random Access Memories), Flash Memory and other forms of random access and related memories that store information in the form of electrical, optical, magnetic, biological or other means. Dynamic memory device types may include asynchronous memory devices such as FPM DRAMs (Fast Page Mode Dynamic Random Access Memories), EDO (Extended Data Out) DRAMs, BEDO (Burst EDO) DRAMs, SDR (Single Data Rate) Synchronous DRAMs, DDR (Double Data Rate) Synchronous DRAMs or any of the expected follow-on devices such as DDR2, DDR3, DDR4 and related technologies such as Graphics RAMs, Video RAMs, LP RAM (Low Power DRAMs) which are often based on the fundamental functions, features and/or interfaces found on related DRAMs.

Memory devices may be utilized in the form of chips (die) and/or single or multi-chip packages of various types and configurations. In multi-chip packages, the memory devices may be packaged with other device types such as other memory devices, logic chips, analog devices and programmable devices, and may also include passive devices such as resistors, capacitors and inductors. These packages may include an integrated heat sink or other cooling enhancements, which may be further attached to the immediate carrier or another nearby carrier or heat removal system.

Module support devices (such as buffers, hubs, hub logic chips, registers, PLL's, DLL's, non-volatile memory, etc) may be comprised of multiple separate chips and/or components, may be combined as multiple separate chips onto one or more substrates, may be combined onto a single package or even integrated onto a single device—based on technology, power, space, cost and other tradeoffs. In addition, one or more of the various passive devices such as resistors, capacitors may be integrated into the support chip packages, or into the substrate, board or raw card itself, based on technology, power, space, cost and other tradeoffs. These packages may include an integrated heat sink or other cooling enhancements, which may be further attached to the immediate carrier or another nearby carrier or heat removal system.

Memory devices, hubs, buffers, registers, clock devices, passives and other memory support devices and/or components may be attached to the memory subsystem and/or hub device via various methods including soldered interconnects, conductive adhesives, socket structures, pressure contacts and other methods which enable communication between the two or more devices via electrical, optical or alternate means.

The one or more memory modules (or memory subsystems) and/or hub devices may be electrically connected to the memory system, processor complex, computer system or other system environment via one or more methods such as soldered interconnects, connectors, pressure contacts, conductive adhesives, optical interconnects and other communication and power delivery methods. Connector systems may include mating connectors (male/female), conductive contacts and/or pins on one carrier mating with a male or female connector, optical connections, pressure contacts (often in conjunction with a retaining mechanism) and/or one or more of various other communication and power delivery methods. The interconnection(s) may be disposed along one or more edges of the memory assembly and/or placed a distance from an edge of the memory subsystem depending on such application requirements as ease-of-upgrade/repair, available space/volume, heat transfer, component size and shape and other related physical, electrical, optical, visual/physical access, etc. Electrical interconnections on a memory module are often referred to as contacts, or pins, or tabs. Electrical interconnections on a connector are often referred to as contacts or pins.

As used herein, the term memory subsystem refers to, but is not limited to: one or more memory devices; one or more memory devices and associated interface and/or timing/control circuitry; and/or one or more memory devices in conjunction with a memory buffer, hub device, and/or switch. The term memory subsystem may also refer to one or more memory devices, in addition to any associated interface and/or timing/control circuitry and/or a memory buffer, hub device or switch, assembled into a substrate, a card, a module or related assembly, which may also include a connector or similar means of electrically attaching the memory subsystem with other circuitry. The memory modules described herein may also be referred to as memory subsystems because they include one or more memory devices and hub devices

Additional functions that may reside local to the memory subsystem and/or hub device include write and/or read buffers, one or more levels of memory cache, local pre-fetch logic, data encryption/decryption, compression/decompression, protocol translation, command prioritization logic, voltage and/or level translation, error detection and/or correction circuitry, data scrubbing, local power management circuitry and/or reporting, operational and/or status registers, initialization circuitry, performance monitoring and/or control, one or more co-processors, search engine(s) and other functions that may have previously resided in other memory subsystems. By placing a function local to the memory subsystem, added performance may be obtained as related to the specific function, often while making use of unused circuits within the subsystem.

Memory subsystem support device(s) may be directly attached to the same substrate or assembly onto which the memory device(s) are attached, or may be mounted to a separate interposer or substrate also produced using one or more of various plastic, silicon, ceramic or other materials which include electrical, optical or other communication paths to functionally interconnect the support device(s) to the memory device(s) and/or to other elements of the memory or computer system.

Information transfers (e.g. packets) along a bus, channel, link or other naming convention applied to an interconnection method may be completed using one or more of many signaling options. These signaling options may include such methods as single-ended, differential, optical or other approaches, with electrical signaling further including such methods as voltage or current signaling using either single or multi-level approaches. Signals may also be modulated using such methods as time or frequency, non-return to zero, phase shift keying, amplitude modulation and others. Voltage levels are expected to continue to decrease, with 1.5V, 1.2V, 1V and lower signal voltages expected consistent with (but often independent of) the reduced power supply voltages required for the operation of the associated integrated circuits themselves.

One or more clocking methods may be utilized within the memory subsystem and the memory system itself, including global clocking, source-synchronous clocking, encoded clocking or combinations of these and other methods. The clock signaling may be identical to that of the signal lines themselves, or may utilize one of the listed or alternate methods that is more conducive to the planned clock frequency(ies), and the number of clocks planned within the various subsystems. A single clock may be associated with all communication to and from the memory, as well as all clocked functions within the memory subsystem, or multiple clocks may be sourced using one or more methods such as those described earlier. When multiple clocks are used, the functions within the memory subsystem may be associated with a clock that is uniquely sourced to the subsystem, or may be based on a clock that is derived from the clock related to the information being transferred to and from the memory subsystem (such as that associated with an encoded clock). Alternately, a unique clock may be used for the information transferred to the memory subsystem, and a separate clock for information sourced from one (or more) of the memory subsystems. The clocks themselves may operate at the same or frequency multiple of the communication or functional frequency, and may be edge-aligned, center-aligned or placed in an alternate timing position relative to the data, command or address information.

Information passing to the memory subsystem(s) will generally be composed of address, command and data, as well as other signals generally associated with requesting or reporting status or error conditions, resetting the memory, completing memory or logic initialization and other functional, configuration or related information. Information passing from the memory subsystem(s) may include any or all of the information passing to the memory subsystem(s), however generally will not include address and command information. This information may be communicated using communication methods that may be consistent with normal memory device interface specifications (generally parallel in nature), the information may be encoded into a ‘packet’ structure, which may be consistent with future memory interfaces or simply developed to increase communication bandwidth and/or enable the subsystem to operate independently of the memory technology by converting the received information into the format required by the receiving device(s).

Initialization of the memory subsystem may be completed via one or more methods, based on the available interface busses, the desired initialization speed, available space, cost/complexity objectives, subsystem interconnect structures, the use of alternate processors (such as a service processor) which may be used for this and other purposes, etc. In one embodiment, the high speed bus may be used to complete the initialization of the memory subsystem(s), generally by first completing a training process to establish reliable communication, then by interrogation of the attribute or ‘presence detect’ data associated with the various components and/or characteristics associated with that subsystem, and ultimately by programming the appropriate devices with information associated with the intended operation within that system. In a cascaded system, communication with the first memory subsystem would generally be established, followed by subsequent (downstream) subsystems in the sequence consistent with their position along the cascade interconnect bus.

A second initialization method would include one in which the high speed bus is operated at one frequency during the initialization process, then at a second (and generally higher) frequency during the normal operation. In this embodiment, it may be possible to initiate communication with all of the memory subsystems on the cascade interconnect bus prior to completing the interrogation and/or programming of each subsystem, due to the increased timing margins associated with the lower frequency operation.

A third initialization method might include operation of the cascade interconnect bus at the normal operational frequency(ies), while increasing the number of cycles associated with each address, command and/or data transfer. In one embodiment, a packet containing all or a portion of the address, command and/or data information might be transferred in one clock cycle during normal operation, but the same amount and/or type of information might be transferred over two, three or more cycles during initialization. This initialization process would therefore be using a form of ‘slow’ commands, rather than ‘normal’ commands, and this mode might be automatically entered at some point after power-up and/or re-start by each of the subsystems and the memory controller by way of POR (power-on-reset) logic included in each of these subsystems.

A fourth initialization method might utilize a distinct bus, such as a presence detect bus (such as the one defined in U.S. Pat. No. 5,513,135 to Dell et al., of common assignment herewith), an I2C bus (such as defined in published JEDEC standards such as the 168 Pin DIMM family in publication 21-C revision 7R8) and/or the SMBUS, which has been widely utilized and documented in computer systems using such memory modules. This bus might be connected to one or more modules within a memory system in a daisy chain/cascade interconnect, multi-drop or alternate structure, providing an independent means of interrogating memory subsystems, programming each of the one or more memory subsystems to operate within the overall system environment, and adjusting the operational characteristics at other times during the normal system operation based on performance, thermal, configuration or other changes desired or detected in the system environment.

Other methods for initialization can also be used, in conjunction with or independent of those listed. The use of a separate bus, such as described in the fourth embodiment above, also offers the advantage of providing an independent means for both initialization and uses other than initialization, such as described in U.S. Pat. No. 6,381,685 to Dell et al., of common assignment herewith, including changes to the subsystem operational characteristics on-the-fly and for the reporting of and response to operational subsystem information such as utilization, temperature data, failure information or other purposes.

With improvements in lithography, better process controls, the use of materials with lower resistance, increased field sizes and other semiconductor processing improvements, increased device circuit density (often in conjunction with increased die sizes) will help facilitate increased function on integrated devices as well as the integration of functions previously implemented on separate devices. This integration will serve to improve overall performance of the intended function, as well as promote increased storage density, reduced power, reduced space requirements, lower cost and other manufacturer and customer benefits. This integration is a natural evolutionary process, and may result in the need for structural changes to the fundamental building blocks associated with systems.

The integrity of the communication path, the data storage contents and all functional operations associated with each element of a memory system or subsystem can be assured, to a high degree, with the use of one or more fault detection and/or correction methods. Any or all of the various elements may include error detection and/or correction methods such as CRC (Cyclic Redundancy Code), EDC (Error Detection and Correction), parity or other encoding/decoding methods suited for this purpose. Further reliability enhancements may include operation re-try (to overcome intermittent faults such as those associated with the transfer of information), the use of one or more alternate or replacement communication paths to replace failing paths and/or lines, complement-re-complement techniques or alternate methods used in computer, communication and related systems.

The use of bus termination, on busses as simple as point-to-point links or as complex as multi-drop structures, is becoming more common consistent with increased performance demands. A wide variety of termination methods can be identified and/or considered, and include the use of such devices as resistors, capacitors, inductors or any combination thereof, with these devices connected between the signal line and a power supply voltage or ground, a termination voltage or another signal. The termination device(s) may be part of a passive or active termination structure, and may reside in one or more positions along one or more of the signal lines, and/or as part of the transmitter and/or receiving device(s). The terminator may be selected to match the impedance of the transmission line, or selected via an alternate approach to maximize the useable frequency, operating margins and related attributes within the cost, space, power and other constraints.

Technical effects and benefits include providing automatic read data flow control in a cascade interconnect memory system. The read data buffer delay does not need to be transmitted to the hub as part of each read request command. It is determined on the fly based on the read request traffic down the channel and the learned read data latency of each hub. In addition, the controller calculates expected data return times. Exemplary embodiments remove the need for any data valid indication (or tag) to be sent upstream to the memory controller as part of the read data and allow for tight return data packing to fully leverage available memory channel bandwidth.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, it will be understood that the use of the terms first, second, etc. do not denote any order or importance, but rather the terms first, second, etc. are used to distinguish one element from another.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer-usable or computer-readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A hub device comprising:
an interface to a channel in a cascade interconnect memory system for connecting the hub device to an upstream hub device or a memory controller, the channel including an upstream bus and a downstream bus; and
read data flow control logic for determining when to transmit data on the upstream bus, the determining responsive to an order of commands received on the downstream bus and to current traffic on the upstream bus.

2. The hub device of claim 1 further comprising a read data buffer, wherein the determining includes calculating a read data buffer delay for a read command and data associated with the read command is held in the read data buffer for the amount of time specified by the calculated read data buffer delay.

3. The hub device of claim 2 wherein the read data flow control logic further initiates transmitting the data associated with the read command on the upstream bus after it has been held in the read data buffer for the amount of time specified by the read data buffer delay.

4. The hub device of claim 1 wherein the read data flow control logic monitors commands received by the hub device on the downstream bus to keep track of the order of commands received on the downstream bus and to determine the current traffic on the upstream bus.

5. The hub device of claim 1 wherein the read data flow control logic stores a read data latency for memory devices accessed by the hub device and for other memory devices accessed by other hub devices in the cascade interconnect memory system, and the read data latencies are utilized by the read data flow control logic as an input to determining the current traffic on the upstream bus.

6. The hub device of claim 1 wherein a read command directed to one of the other memory devices is utilized by the read data flow control logic for determining when to transmit data on the upstream bus.

7. The hub device of claim 1 wherein the determining is independent of other hub devices in the cascade interconnect memory system and the determining is independent of a memory controller in the cascade interconnect memory system.

8. A memory system comprising:
a memory channel including an upstream bus and a downstream bus;
a memory controller in communication with the memory channel and including memory controller read data flow control logic for determining an expected return time of read data associated with a read command issued by the memory controller; and
a hub device including:
an interface to the memory channel for connecting the hub device to the memory controller or for cascade interconnecting the hub device to an upstream hub device in the memory system; and
hub device read data flow control logic for determining when to transmit the read data on the upstream bus, the determining responsive to an order of commands received on the downstream bus and to current traffic on the upstream bus.

9. The memory system of claim 8 wherein the hub device further comprises a read data buffer, wherein the determining when to transmit the read data includes calculating a read data buffer delay for the read command and the read data associated with the read command is held in the read data buffer for the amount of time specified by the calculated read data buffer delay.

10. The memory system of claim 9 wherein the read data flow control logic further initiates transmitting the read data associated with the read command on the upstream bus after it has been held in the read data buffer for the amount of time specified by the read data buffer delay.

11. The memory system of claim 8 wherein the read data flow control logic monitors commands received by the hub device on the downstream bus to keep track of the order of commands received on the downstream bus and to determine the current traffic on the upstream bus.

12. The memory system of claim 8 wherein the read data flow control logic stores a read data latency for memory devices accessed by the hub device and for other memory devices accessed by other hub devices in the cascade interconnect memory system, and the read data latencies are utilized by the read data flow control logic as an input to determining the current traffic on the upstream bus.

13. The memory system of claim 12 wherein the read data latencies are generated in response to a command from the memory controller.

14. The memory system of claim 12 wherein the read data latencies are updated on a periodic basis during memory system runtime.

15. The memory system of claim 8 wherein a read command directed to one of the other memory devices is utilized by the read data flow control logic for determining when to transmit data on the upstream bus.

16. The memory system of claim 8 wherein the determining when to transmit the read data is independent of other hub devices in the cascade interconnect memory system and the determining when to transmit the read data is independent of the memory controller.

17. A method for automatic read data flow, the method comprising:
receiving a downstream memory channel block at a hub device in a cascade interconnect memory system, the receiving via an upstream bus;
determining if the downstream memory channel block includes a read command;
decrementing an outstanding read data latency (ORDL) counter if the downstream memory channel block does not include a read command;
if the downstream memory channel block includes a read command then calculating a read data buffer delay (RDBD) for the read command, a read data latency (RDL) for each frame of data returned in response to the read command, and a new ORDL based on the RDBD and the RDL; and
if the downstream memory channel block includes a read command and the read command is directed to a memory device associated with the hub device then transmitting the one or more data frames returned in response to the read command on the upstream bus after holding the data for the amount of time specified by the RDBD.

18. The method of claim 17 wherein the calculating the RDBD is responsive to an initial frame latency (IFL) associated with the memory device and the ORDL counter.

19. The method of claim 17 wherein the calculating the RDL is responsive to the IFL, RDBD, a subsequent frame latency (SFL) associated with the memory device and a number of data frames returned by the read command.

20. A design structure tangibly embodied in a machine readable medium for designing, manufacturing, or testing an integrated circuit, the design structure comprising:
a hub device comprising:
an interface to a channel in a cascade interconnect memory system for connecting the hub device to an upstream hub device or a memory controller, the channel including an upstream bus and a downstream bus; and
read data flow control logic for determining when to transmit data on the upstream bus, the determining responsive to an order of commands received on the downstream bus and to current traffic on the upstream bus.
